(19) United States
(12) Patent Application Publication
(10) Pub. No.: US 2008/0257797 A1
(43) Pub. Date: Oct. 23, 2008

(54) Sealing Feature for Sorter Paddles

(75) Inventors: Gregory Nowak, Fairview, PA (US); Christopher Cedzo, Fairview, PA (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: Eriez Manufacturing Co.

(21) Appl. No.: 12/105,723

(22) Filed: Apr. 18, 2008

Related U.S. Application Data
(60) Provisional application No. 60/912,566, filed on Apr. 18, 2007.

(51) Int. Cl. B07C 5/36; F16J 15/16

(52) U.S. Cl. 209/606; 277/500

(57) ABSTRACT

A motorized paddle assembly for a material sorter is presented. The motorized paddle assembly comprises a paddle, internal mechanisms, and a housing that encloses the internal mechanisms. The paddle is attached to a circular hinge to enable the circular hinge and the paddle to rotate about an axis. The motorized paddle assembly includes an upper plate for the circular hinge. The upper plate allows the free rotation of the circular hinge while substantially preventing unwanted material from falling behind the circular hinge. In a series of adjacent motorized paddle assemblies, a gasket is mounted between adjacent motorized paddle assemblies to substantially prevent unwanted material from falling between the adjacent motorized paddle assemblies.

This application takes priority from U.S. provisional application 60/912,566 filed Apr. 18, 2007, which is incorporated herein by reference.

### BACKGROUND

The recycling industry sorts and separates reusable materials out of collected materials. The sorted and separated reusable materials are reprocessed into raw materials in other applications while the unusable material is typically sent to a landfill. Machines, called sorters, are often used to mechanically sort and separate a variety of types of materials from a material stream. The material stream is passed through the detection range of any of a variety of sensors that detect metals, plastics, glass, or other parameters like size and color that can be sorted and separated from the material stream.

### SUMMARY

A motorized paddle assembly for a material sorter is presented. The motorized paddle assembly comprises a paddle, internal mechanisms, and a housing that encloses the internal mechanisms. The paddle is attached to a circular hinge to enable the circular hinge and the paddle to rotate about an axis. The motorized paddle assembly includes an upper plate for the circular hinge. The upper plate allows the free rotation of the circular hinge while substantially preventing unwanted material from falling behind the circular hinge.

Some embodiments of motorized paddle assemblies have two hinges for each paddle. In these embodiments, the upper plate has openings for each hinge.

In a series of adjacent motorized paddle assemblies, a gasket is mounted between adjacent motorized paddle assemblies to substantially prevent unwanted material from falling between the adjacent motorized paddle assemblies.

Some embodiments can have a seal between the circular hinge and the internal mechanisms of the motorized paddle assembly. This seal can be made of felt or any other appropriate material and can be oil impregnated.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is an embodiment of a sorter that can incorporate an array of control modules as described herein;

FIG. 2 is a schematic showing a prior art control system of a sorter;

FIG. 3A is a perspective view of one embodiment of a motorized paddle that could be used in a control module;

FIG. 3B is a perspective rear view of the motorized paddle of FIG. 3A;

FIG. 3C is a cross-sectional view of the motorized paddle of FIG. 3B along the Section line 3C-3C;

FIG. 4 is a perspective view of an upper plate that is inserted between a paddle and motorized paddle assembly housing;

FIG. 5 is a perspective view of two adjacent motorized paddle assemblies that incorporate an embodiment of the sealing features;

FIG. 6 is a perspective view of the front of four adjacent motorized paddle assemblies that incorporate an embodiment of the sealing features; and

FIG. 7 is a perspective view of the rear of five adjacent motorized paddle assemblies that incorporate an embodiment of the sealing features.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

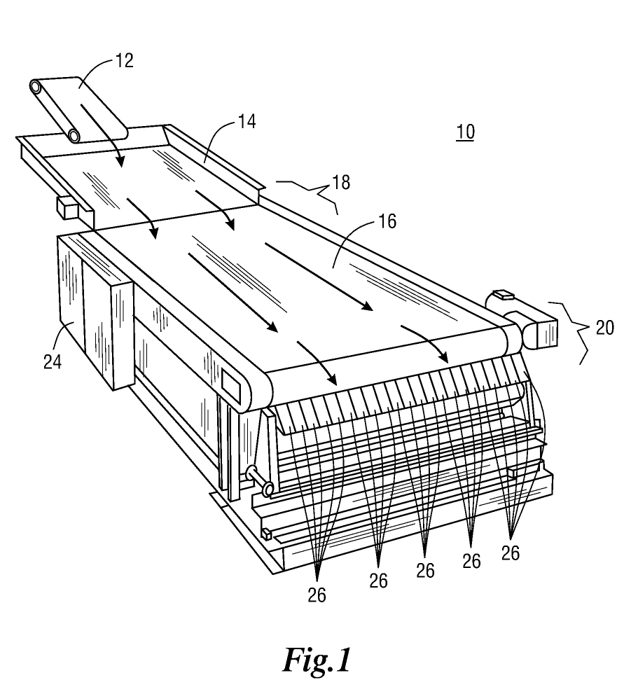

Sorters in the recycling industry use a variety of methods to detect and sort different types of material from a material stream. FIG. 1 shows an example of such a sorter 10. The sorter 10 is a ProSort manufactured by Eriez Magnetics located in Erie, Pa. The sorter 10 accepts material from upstream sources 12 and has a material introduction system 14 that is a vibrating chute angled to deposit a material stream onto the width of a material handling system 16. The material handling system 16 comprises a conveyor belt that transports the material stream from about a first end 18 where the material stream is deposited to about a second end 20.

This sorter 10 has a material detection system that comprises at least one sensor that is positioned to detect materials in the material stream. The sensor or sensors are able to detect at least one type of material in the material stream within their range of effectiveness and are arranged to be effective substantially across the width of the material handling system 16. The sensor or sensors are controlled by a control system located in the control system housing 24. The sorter 10 is able to sort the material in the material stream based on the readings of the sensor or sensors. This sorting is conducted by a sorting system that comprises a series of motorized paddles assemblies 26.

The material stream passes through the detection range of the material detection system as it is conveyed from the first end 18 to the second end 20. When a sensor of the material detector detects a target type of material in the material stream, the control system in the control system housing 24 either sends a timed signal to the corresponding motorized paddle assembly 26 to deflect the material or does nothing and lets the material drop past the motorized paddle assemblies 26 as required by the current configuration of the sorter 10.

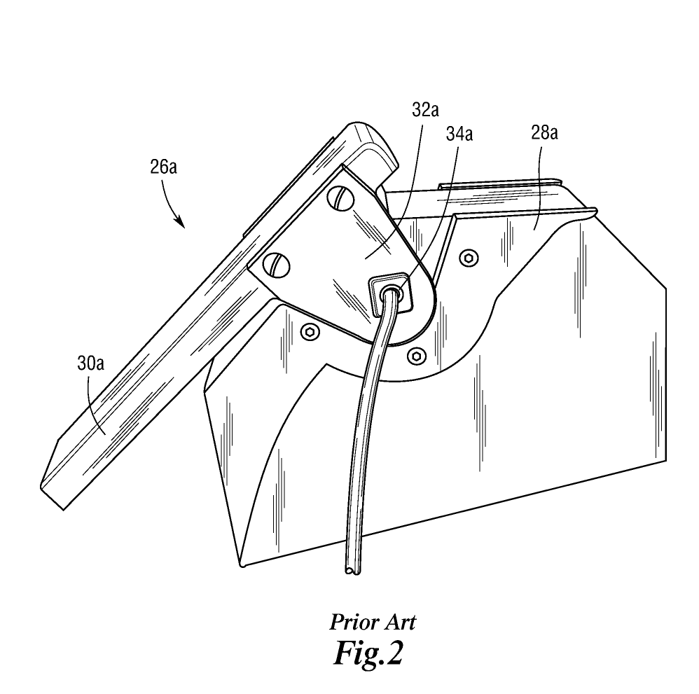

FIG. 2 shows a prior art motorized paddle assembly 26a, which comprises a housing 28a that encloses the internal mechanism (not shown) that operates the motorized paddle assembly 26a, a paddle 30a mounted to a hinge 32a, and a cable connector 34a that connects the motorized paddle assembly 26a to the sorter control system. The cable connector 34a sends and receives signals between the sorter control system and the motorized paddle assembly 26a. These motorized paddle assemblies 26a operate in high dust and grit environments. The housing 28a has a shoulder in which the hinge 32a sits that defines the range of motion of the hinge 32a. An opening (not shown) in the housing 28a connects the hinge 32a to the internal mechanism of the motorized paddle assembly 26a. The prior art embodiment shown in FIG. 2 is subject to frequent breakdowns and high maintenance costs. The prior art hinge 32a is prone to debris falling behind the hinge 32a. Debris, dust, and grit builds up over time and physically impedes the range of motion of the hinge 32a. There is a chance that some of the accumulating debris may work its way into the motorized paddle assembly 26a housing 28a. If this happens, the debris could interfere with the operation of the internal mechanisms and control circuitry (not shown) of the motorized paddle assembly 26a. When multiple prior art motorized paddles 26a are installed in series on sorters as shown, for example in FIG. 1, gaps between each motorized paddle assembly 26a allow debris to build up between each motorized paddle assembly 26a. Over time the debris builds up to the level of the cable connector 34a. The debris can impinge and damage the cable connector 34a.

Some prior art embodiments incorporate magnets as part of the internal mechanism within the housing 28a. These magnets operate within the motorized paddle assembly 26a with narrow clearances. As many of these devices are installed in environments in which they are exposed to ferrous material in the form of rust, dust, or other matter, the lack of a good seal means that these prior art devices constantly attract ferrous debris that causes the internal mechanisms to fail with debris fouling the internal mechanisms or interfering with the narrow clearances.

All of these limitations cause damage that would require maintenance or replacement of the motorized paddle assemblies 26a and could put the sorter out of commission while the problem is addressed. This wasted downtime represents a significant bottleneck in a facility's productivity.

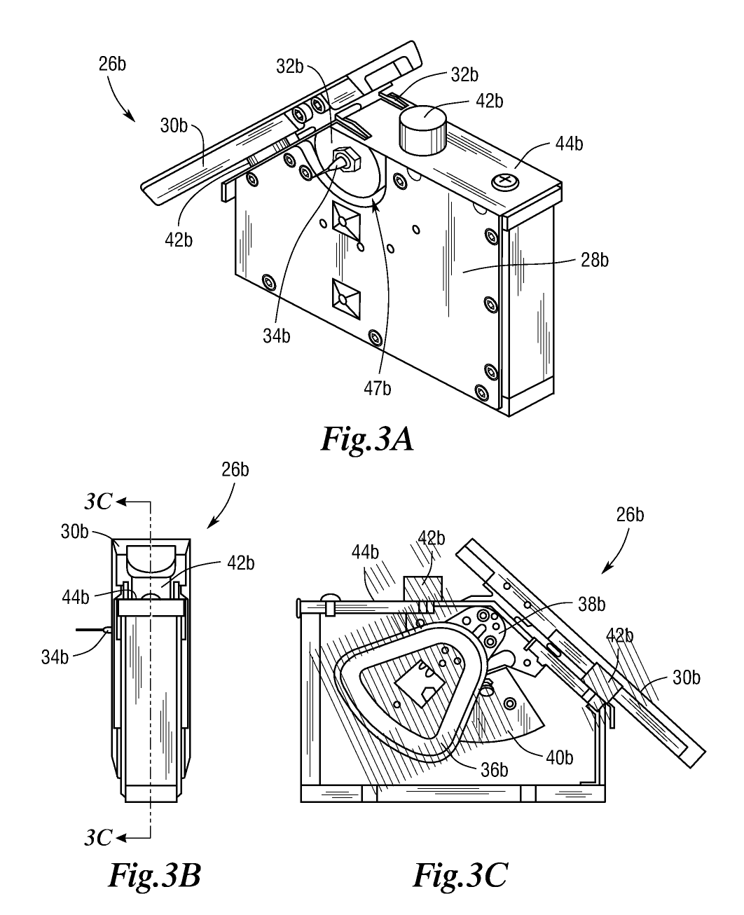

Various embodiments of the invention have been developed to address these limitations. One embodiment is shown depicted in FIG. 3A. As can be best understood by comparing FIGS. 3A-3C, the motorized paddle assembly 26b comprises a paddle 30b, internal mechanisms (described below), and a housing 28b to cover and protect the internal mechanism. The paddle 30b is attached to hinge 32b. The housing 28b has a shoulder in which the hinge 32b is seated. An opening (not shown) in the housing 28b allows the hinge 32b to be attached to bearings (not shown) that are connected a shaft 38b. An electromagnetic coil 36b is suspended from the shaft 39b. The bearings (not shown) allow the shaft 38b and the electromagnetic coil 36b to swing freely. The electromagnetic coil 36b is sandwiched between two sets of fixed permanent magnets 40b (only one set is shown in the figures). The electromagnetic coil 36b is close to the magnets 40b but does not touch them. There is a clearance of about 0.030 inches on either side of the electromagnetic coil 36b between the magnets 40b and the electromagnetic coil 36b.

The motorized paddle assembly 26b is connected to the module's control circuitry (not shown) through the motorized paddle assembly cable connector 34b. When the motorized paddle assembly 26b is at rest, a −5 VDC (Voltage, Direct Current) is applied to the leads (not shown) of the electromagnetic coil 36b. This creates a magnetic field in the electromagnetic coil 36b that causes the electromagnetic coil 36b to swing on the shaft 38b and align itself to the appropriate opposite polarity of the magnets 40b and causes the paddle 30b to remain in the rest position. When the motorized paddle assembly 26b is actuated, a +16.5 VDC voltage is sent to the leads (not shown) of the electromagnetic coil 36b that causes the electromagnetic coil 36b to align itself with the magnets 40b towards the front of the housing 38b. This correspondingly causes the paddle 30b to swing outwards. A −5 VDC current is applied to return the paddle 30b to the retracted position. Shock absorbers 42b absorb some of the vibration experienced by the paddle 30b during actuation and return. As mentioned above, the small clearances between the magnets 40b and the electromagnetic coil 36b are susceptible to fouling if the motorized paddle assembly 26b is not properly sealed. The motorized paddle assembly cable connector 34b allows the control circuitry to monitor signals received from the motorized paddle assembly 26b and to provide signals to the motorized paddle assembly 26b as needed.

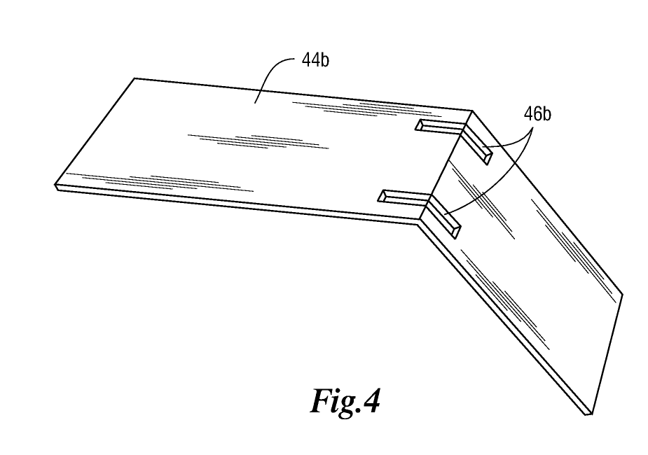

In order to reduce the chances of the paddle 30b of the motorized paddle assemblies 26b getting stuck, the hinges 32b on which the paddle 30b rotates are circular. Any debris that falls behind the hinge is unlikely to impinge the range of motion of the hinge 32b. An upper plate 44b is mounted on the motorized paddle assembly 26b to further reduce the amount and size of debris that can fall behind the hinge 32b. As can be understood by comparing FIGS. 3A and 4, the upper plate 44b has openings 46b sized to fit the hinges 32b that allows the hinges 32b to move their full range of motion while substantially blocking dust and debris from falling behind the hinges 32b.

A seal 47b can be included between the hinge 32b and the housing 28b to keep dirt and moisture away from the bearings and to also act as a wiper for the circular hinge 32b. The seal 47b surrounds the opening in the housing 28b and is sufficiently large to cover the back of the hinge so that dirt cannot get between the hinge 32b and the housing 28b. The seal 47b can be made of felt or any other appropriate material and can be oil impregnated if appropriate. The seal provides an additional level of protection from dust and debris entering the housing 26b and damaging the inner mechanisms of the motorized paddle assembly 26b.

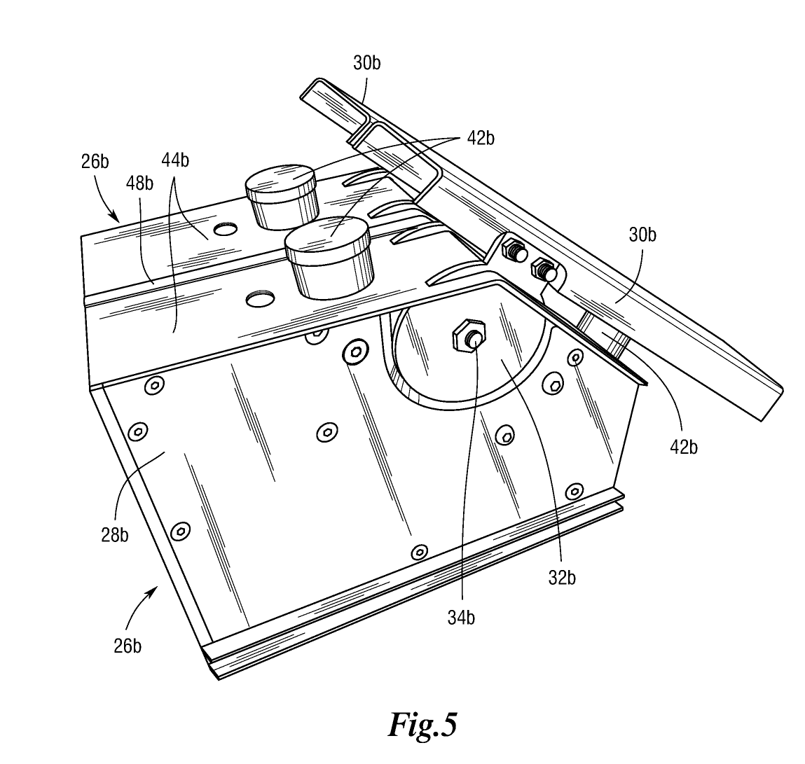

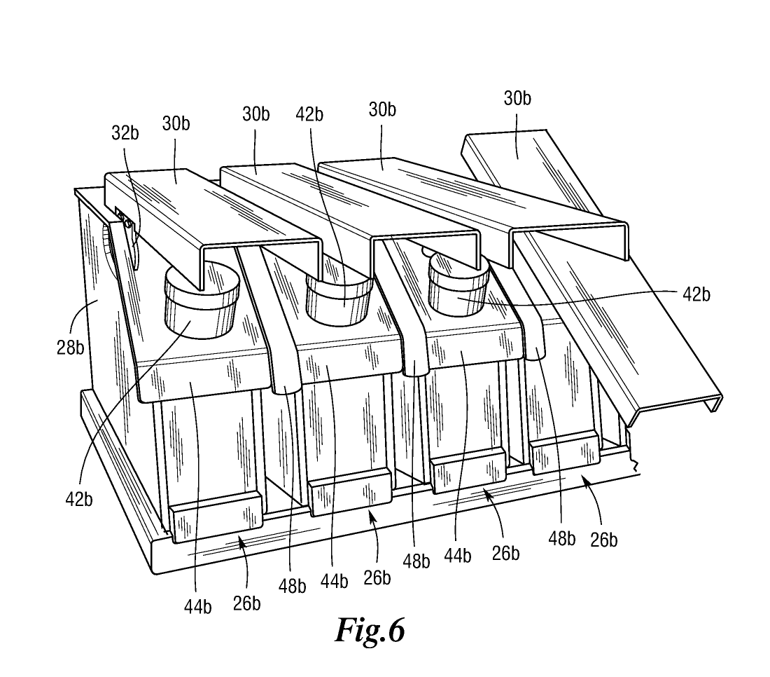

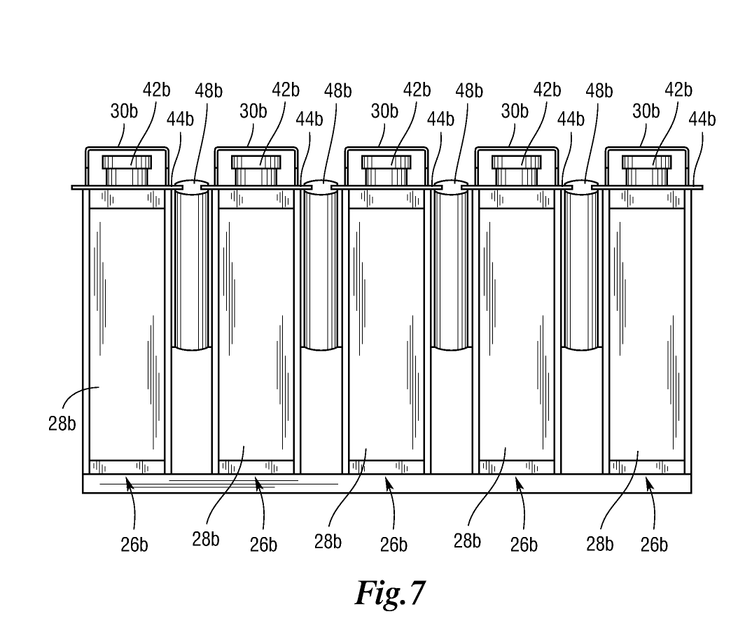

Multiple motorized paddle assemblies 26b are arranged side by side on sorters as shown in FIGS. 5, 6 and 7. To further seal the array of motorized paddle assemblies 26b against dust and grit collecting between individual motorized paddle assemblies 26b, gaskets 48b are installed between adjacent motorized paddle assemblies 26b. This reduces the build up of grit between the motorized paddle assemblies 26b that could eventually pinch or sever any cable connections to/from the motorized paddle assemblies 26b or impede the range of motion of the hinges 32b. FIGS. 5 6, and 7 show the gaskets 48b mounted to the upper plates 44b of adjacent motorized paddle assemblies 26b, but other configurations of gaskets 48b are possible so long as dust and debris are substantially blocked from falling between the motorized paddle assemblies 26b.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A motorized paddle assembly for a material sorter including a paddle, internal mechanisms, and a housing that encloses the internal mechanisms, the motorized paddle assembly comprising:
a circular hinge to which the paddle is attached to enable said circular hinge and the paddle to rotate about an axis; and
an upper plate for said circular hinge, said upper plate configured to allow the free rotation of said circular hinge while substantially preventing unwanted material from falling behind said circular hinge.

2. The motorized paddle assembly of claim 1 further comprising two said circular hinges.

3. The motorized paddle assembly of claim 1 further comprising a seal between said circular hinge and the internal mechanisms of the motorized paddle assembly.

4. The motorized paddle assembly of claim 1 further comprising an oil impregnated felt seal between said circular hinge and the internal mechanisms of the motorized paddle assembly.

5. An array of motorized paddle assemblies for a material sorter comprising a series of adjacent motorized paddle assemblies, the motorized paddle assemblies each including a paddle, internal mechanisms, and a housing that encloses the internal mechanisms, the array of motorized paddle assemblies comprising:
each paddle attached to a circular hinge to enable each paddle and said circular hinge to rotate about an axis;
each motorized paddle assembly having a upper plate mounted for said circular hinge, said upper plate configured to allow the free rotation of said circular hinge while substantially preventing unwanted material from falling behind said circular hinge; and
a gasket between adjacent motorized paddle assemblies to substantially prevent unwanted material from falling between adjacent motorized paddle assemblies.

6. The array of motorized paddle assemblies of claim 5 further comprising each paddle having two said circular hinges.

7. The array of motorized paddle assemblies of claim 5 further comprising a seal between said circular hinge and the internal mechanisms of the motorized paddle assembly.

8. The array of motorized paddle assemblies of claim 5 further comprising an oil impregnated felt seal between said circular hinge and the internal mechanisms of the motorized paddle assembly.
